(19) United States
(12) Patent Application Publication
(10) Pub. No.: US 2025/0174155 A1
(43) Pub. Date: May 29, 2025

(54) SIMULATOR SYSTEM FOR CARRYING OUT MEASUREMENTS FOR STANDARD CONTROL OF ACOUSTIC PROPERTIES OF MIDDLE EAR IMPLANTS ON A MECHANICAL MODEL OBJECT

(71) Applicant: Heinz Kurz GmbH, Dusslingen (DE)

(72) Inventors: Alexander Sander, Titisee-Neustadt (DE); Thomas Stiegele, Riederich (DE); Matthias Mertens, Kaltenkirchen (DE)

(73) Assignee: Heinz Kurz GmbH, Dusslingen (DE)

(21) Appl. No.: 18/959,566

(22) Filed: Nov. 25, 2024

(30) Foreign Application Priority Data
Nov. 29, 2023 (DE) 20 2023 107064.7

(51) Int. Cl. G09B 23/30

(52) U.S. Cl. CPC G09B 23/30

(57) ABSTRACT

A simulator system for measuring acoustic properties of passive middle ear implants, with a physical ear model for biometric simulation the human ear, includes a first functional portion modeling the human middle ear, an acoustic detection device measuring parameters of a middle ear implant, and an evaluation module storing and evaluating the measured parameter data. The physical ear model contains exclusively artificial materials including plastics and/or metal parts. The ear model has a second functional portion modeling the human inner ear and has a closed cavity filled with liquid. The detection device has a pressure probe arranged on an outer wall or within the closed cavity with a hydrophone within the cavity arranged on an inner surface of the cavity in the liquid. An electrical signal line leads from the detection device to the evaluation module in a sealed manner through the cavity and leads into the hydrophone.

### CROSS-REFERENCE TO RELATED APPLICATIONS

This application claims priority to German Patent Application No. DE 20 2023 107 064.7, filed Nov. 29, 2023, the entire contents of which are hereby incorporated in full by this reference.

### DESCRIPTION

### Field of the Invention

The invention relates to a simulator system for carrying out measurements of acoustic properties of passive middle ear implants, with a physical ear model for simulating parts of the human ear, comprising a first functional portion, which models the human middle ear, with a detection device for measuring selected, time-varying acoustic parameters of a middle ear implant inserted into the first functional portion, and with an evaluation module, which stores and evaluates parameter data measured with the detection device.

### Background of the Invention

Such a device is known from the ASTM F2504-05 standard (=reference [1]).

The invention generally relates to the validation in the field of hearing implants that are to be inserted into the human ear and are to be tested for technical suitability beforehand.

In general, a standardized performance evaluation of middle ear implants for human applications is performed with human temporal bone preparations during the development phase so that human temporal bone preparations have so far been indispensable for testing middle ear prostheses for standard conformity, as also proposed and described in reference [1].

However, it is generally difficult to obtain permanently well-reproducible experimental results under all circumstances when using anatomical preparations from cadaver parts, especially since the supply of cadavers is extremely limited due to various national regulations, at least in industrialized countries, and the demand for them is correspondingly high. In many countries, there is a certain shortage of human cadavers or cadaver parts. On the one hand, cadavers and cadaver parts are expensive in operation and, in some countries, very difficult or even impossible to access due to ethical considerations or corresponding legislation.

In addition, each cadaver naturally has different physical and chemical properties and the corresponding cadaver parts are generally relatively sensitive to changing environmental factors such as temperature and humidity, which affects storability.

There is therefore a high demand for test systems of the type defined at the beginning, with which the parameters required by the standard according to reference [1] can be measured under the most realistic conditions possible and in the most reproducible manner possible, without having to resort to human bodies or body parts, wherein, however, a realistically modeled measurement environment as in the measurements with cadaver parts described in reference [1] should nevertheless exist.

When carrying out the test procedure in relation to the standard in accordance with reference [1], human temporal bones (see 6.2.1) are normally used. The human temporal bone is a recognized model (see 5.3) that closely follows the biomechanics of the living middle ear.

Furthermore, the ASTM F2504-05 standard describes inter alia how the transfer function of implantable middle ear hearing aids and/or middle ear implants must be recorded and interpreted on human petrous bone preparations ex vitro by means of laser Doppler vibrometry.

This ASTM F2504-05 standard is also used internationally for passive middle ear implants and is currently used exclusively.

The publication “A 3D-printed functioning anatomical human middle ear model” by I. Kuru et al. (=reference [2]) describes an apparatus that is at least partially produced by means of 3D printing, is to model the human middle ear and, in principle, does not require the use of human cadaver parts. Here, too, the use of a laser Doppler vibrometer is mandatory. However, the attenuation effects caused by the fluid in the inner ear are not taken into account here either. Furthermore, reference [2] deals only with the creation and handling of a physical middle ear model but not with the testing and evaluation of implantable middle ear prostheses.

A problem with the proposals in both reference [1] and reference [2] is the mandatory use of a very expensive but nevertheless error-prone and space-consuming laser Doppler vibrometer.

### Proposals in Literature in the Field of Medical Training Systems

While the present invention as well as the generic reference [1] are exclusively concerned with the validation of middle ear prostheses that are to be implantable into the human ear, possibilities of using apparatuses with realistic otological environments are also being discussed in technically more distant fields in connection with medical training systems. The aim is generally to provide a training system that allows surgeons to practice as many of the typical steps of a real operation as possible in the model and in so doing to improve their corresponding skills.

DE 10 2018 118 918 B3 (=reference [3]) describes a training system for carrying out surgical procedures on a mechanical model object with an anatomical preparation or a simulation unit for representing parts of the human body. However, in principle, the training system described in reference [3] cannot simulate implantation and naturally does not allow measurement and validation of implantable middle ear prostheses.

DE 10 2005 041 942 A1 (=reference [4]) describes a similar training system to that in reference [3], with a simulation unit for representing parts of the human body, which, however, does not have a second functional portion that models an area of the human soft tissue system. Only tympanoplasties are provided, but no stapesplasties, no cartilage tissue, and no soft tissue.

A similar training system as in reference [3], but here with an anatomical preparation based on cadaver parts, is known from the publication by G. Strauss et al., “Evaluation eines Trainingssystems für die Felsenbeinchirurgie mit opto-elektronischer Detektion” [Evaluation of a training system for petrosal bone surgery with opto-electronic detection], HNO 2009. 57:999-1009, Springer Medizin Verlag, Aug. 20, 2009 (=reference [5]). No manipulation through an implant is provided here, either.

The publication by Shawn B. Mathews et al., “Incus and Stapes Footplate Simulator,” Laryngoscope 107: December 1997, 1614-1616 (=reference [6]) describes a simulator for incus and stapes footplate, which simulator is to offer a practice opportunity to improve otological-surgical skills.

However, the simulator there does not correspond to real anatomical conditions.

The same applies to the publication by A. O. Owa et al., “A middle-ear simulator for practicing prostheses placement for otosclerosis surgery using ward-based materials,” The Journal of Laryngology & Otology, June 2003, Vol. 117, pp. 490-492 (=reference [7]), which describes a middle ear simulator for training on the implantation of middle ear prostheses.

The same also applies to the publication by Robert Mills et al., “Surgical skills training in middle-ear surgery,” The Journal of Laryngology & Otology, March 2003, vol. 117, pp. 159-163 (=reference [8]), which provides an overview of otological-surgical training opportunities in 2002. The described arrangements are simulators purely for anatomical teaching purposes. Measurement and validation of implantable middle ear prostheses is not provided here either.

In the article “3D Printed Pediatric Temporal Bone: A Novel Training Model,” Otology & Neurotology, 2015, 36:793-795 (=reference [9]), Evan A. Longfield et al. describe a 3D-printed pediatric training model with a child's temporal bone. However, this model includes only an image of the bony part of the petrous bone. Any manipulation through an implant is not provided, nor is any representation of the acoustic transfer function after manipulation. The collected data are not processed.

In their publication “A new physical temporal bone and middle ear model with complete ossicular chain for simulating surgical procedures,” Proceedings of the 2015 IEEE Conference of Robotics and Biomimetics, Zhuhai, China, pp. 1654-1659 (=reference [10]), authors Konrad Entsfellner et al. describe a model for the temporal bone and the complete ossicular chain for simulating surgical procedures. No manipulation through an implant is provided here either, nor is there any representation of the acoustic transfer function after manipulation. The collected data are not processed.

In their article “Development and Validation of a Modular Endoscopic Ear Surgery Skills Trainer,” Otology & Neurotology, 2017, 38:1193-1197 (=reference [11]), Matthew M. Dedmon et al. describe a training system for modular endoscopic ear surgery, which, however, does not correspond very closely to the actual anatomical conditions. Furthermore, no manipulation through an implant is provided here either or is there any representation of the acoustic transfer function after manipulation. The collected data is not processed.

In the article “Modifications to a 3D-printed temporal bone model for augmented stapes fixation surgery teaching,” Eur Arch Otorhinolaryngol, 2017, 274:2733-2739 (=reference [12]), Yann Nguyen et al. describe, on the basis of modifications to a 3D-printed temporal bone model, learning opportunities to improve stapes fixation. In particular, a force sensor is provided on the stapes here.

In the publication “From reconstruction to function. Hands-on training in tympanoplasty using real-time feedback,” HNO 7, 2021, 69:556-561 (=reference [13]), T. Beleites et al. provide an overview of risk-free tympanoplasty training with real-time feedback.

### General Literature on Otology

In their textbook article “Surgical anatomy and pathology of the middle ear,” J. Anat. (2016) 228, pp. 338-353 (=reference [14]), Jan Christoffer Luers et al. generally describe the state of middle ear surgery in 2015.

In their publication “Sheep as large animal ear model: Middle-ear ossicular velocities and intracochlear sound pressure” in Hearing Research (2017), vol. 351, pp. 88-97 (=reference [15]), Dominik Peus et al. describe the research into the properties of the cochlea of sheep carcasses, using MEMS-based hydrophones, among other things.

Martin Grossohmichen et al. also discusses the examination of cadavers, albeit in this case using middle ear preparations from dead people, in their article “Validation of methods for prediction of clinical output levels from measurements in human cadaveric ears” in Scientific Reports (2017), vol. 7, no. 1, pp. 1-10 (=reference [16]). However, only active middle ear implants (AMEI), but not passive prostheses, are tested using space-consuming standard laboratory measuring arrangements, in particular with fiber-optic pressure transducers on cadaver parts, wherein acoustic parameters such as the pressure differences of scala vestibuli and scala tympani are ascertained.

CN 110246404 B (=reference [17]) discloses a model that is mechanically modeled on the ear but is by no means designed anatomically to be biometrically correct in terms of the geometric and acoustic properties of the human hearing organ, for illustrating the basic hearing process. Although a functional portion for the inner ear comprises a liquid-filled, closed container, light sources are used in this inner ear model to illustrate nerve impulse transmission. Such a setup is therefore in no way intended or even suitable for a series quality test of the acoustic properties and functions of passive middle ear prostheses. The materials used are also not specified, in particular, not whether only artificial material was used for the model.

In contrast to all surgical learning and training systems described above, reference [1] already mentioned at the beginning defines an international standard for the required standard output of implantable middle ear prostheses. The ASTM F2504-05 standard describes inter alia a generic simulator system for the present invention for carrying out measurements of acoustic properties of passive middle ear implants, with a physical ear model for simulating parts of the human ear and with all of the feature complexes that were defined at the beginning and are mandatory for the present invention.

However, a major problem with this generic apparatus is the use of prepared cadaver parts to anatomically realistically simulate a “standard environment” for the validation of implantable middle ear prostheses. Another disadvantage of this known apparatus is the mandatory use of a laser Doppler vibrometer, among other things.

### SUMMARY OF THE INVENTION

### Object of the Invention

The object of the present invention, on the other hand, is to improve a generic simulator system of the type described at the beginning, using the simplest possible technical means in a simple and cost-effective manner in such a way that the above-described disadvantages and inadequacies of the known device are at least partially avoided. In particular, the invention aims to present a simulator system that uses a biomimetics-based, as realistic as possible physical ear model to simulate the acoustic middle ear properties but does not use anatomical preparations made from cadaver parts for this purpose.

Another aim of the invention is to replace the standard according to reference [1] in the future.

In addition, the simulator system according to the invention should no longer require very expensive and space-consuming laser Doppler vibrometers. Finally, the device should be inexpensive, compact and easy to transport and should be able to achieve measurement results that are as permanently reproducible as possible.

### BRIEF DESCRIPTION OF THE INVENTION

This relatively complex object is achieved according to the invention, based on the features specified at the beginning and in the preamble of claim 1, in a manner that is as surprisingly simple as it is effective and inexpensive to implement in that, quite in contrast to the provisions of reference [1], which could be replaced in the future by the present invention, the physical ear model of the simulator system contains exclusively artificial materials including plastics and/or metal parts, that the physical ear model comprises a second functional portion, which models the human inner ear and has a liquid-filled, closed cavity, that the detection device comprises at least one pressure probe, which is arranged on an outer wall or within the closed cavity of the second functional portion, that the pressure probe comprises a hydrophone, which is arranged, at least partially surrounded by the liquid, within the closed cavity, that the hydrophone is arranged on an inner surface of the closed cavity of the second functional portion, that at least one electrical signal line leads from the detection device to the evaluation module, via which signal line the parameter data measured with the detection device can be transmitted directly to the evaluation module, and that part of the electrical signal line passes in a sealed manner through a wall of the closed cavity and leads into the hydrophone.

The focus in the design of the physical ear model is to simulate the acoustic properties of the human ear, especially the vibration properties of the stirrup of the human temporal bone, according to the physical measurement parameters prescribed in the ASTM F2504-05 standard. In this respect, the static and dynamic properties of the components of the middle ear play an important role.

The novel setup with a closed liquid cavity and the resulting new functionality of the simulator system according to the invention ensure that, in the physical ear model, the environment of the middle ear prosthesis to be measured is represented in an anatomically correct and acoustically realistic manner but without the need for anatomical preparations of cadaver parts.

During normal operation, the pressure probe of the detection device measures the acoustic waves attenuated by the simulated inner ear fluid as in nature and transmits the signals directly to the evaluation module. This makes it possible to represent the attenuation of sound waves, which always exists in nature due to the fluid movement in the cochlea when a sound event occurs, much more realistically than the proposals of references [1] and [2] and thus to significantly improve the measurement data obtained with this apparatus.

This also eliminates the need for a laser Doppler vibrometer, as prescribed in references [1] and [2].

The use of a hydrophone, which is at least partially surrounded by the liquid, within the closed cavity makes it possible to detect even low transmitted alternating sound pressures without having to use complex measuring technology for this purpose. Part of the electrical signal line passes in a sealed manner through a wall of the closed cavity and leads into the hydrophone, which is arranged on an inner surface of the closed cavity of the second functional portion. The hydrophone is flush with the outer skin of the cavity, thus preventing turbulent flows.

Particular advantages of the simulator system according to the invention over the prior art include: ease of use; precise performance evaluation of hearing implants; realistic and reproducible test environment; increased safety, in particular by reducing the risk of contamination; cost savings.

### Preferred Embodiments of the Invention

Embodiments of the invention that are characterized in that the pressure probe comprises an air microphone, which is arranged on an outer wall of the closed cavity and into which part of the electrical signal line leads, are quite particularly preferred.

In the air-microphone variant, the alternating sound pressures to be transmitted are detected additionally or exclusively by an air microphone. In principle, this could even make it possible to dispense with the second functional portion (inner ear).

In practice, developments of these above-described embodiments in which the hydrophone and/or the air microphone of the pressure probe each have a diameter between 0.5 mm and 5 mm, preferably between 1 mm and 2 mm, have proven to be particularly useful.

According to the invention, the actual validation measurement is thus carried out by pressure probes or hydrophones in a simulated, fluid-filled cochlea.

Developments of this class of embodiments of the invention, in which the physical ear model for simulating parts of the human ear comprises a third functional portion, which models the human outer ear and in particular simulates the sound conduction properties thereof, are of particularly great practical advantage.

This third functional portion with the outer ear functions therefore also makes acoustic free-field measurements possible.

In the prior art, no simulator system has yet been described that can represent bone tissue, soft tissue and cartilage. However, this is in particular especially important for applications in otology.

Also of practical advantage are embodiments of the invention that are characterized in that the functional portions are connected to one another via a flange system.

The simulator systems should require only little manual work, or none at all if possible, during production and should be able to be divided into individual, easily assembled modules, and be plugged together. Since the components must be easily separable, they are best not connected with glue or even welded.

Another important class of embodiments of the simulator system according to the invention is characterized in that the first functional portion, which models the human middle ear, has components that simulate the mechanical properties of the tympanic membrane, the ligaments and tendons of the middle ear, the middle ear ossicles and the middle ear joints, in particular the incudomalleolar joint and the incudostapedial joint.

A class of embodiments of the simulator system according to the invention that are characterized in that different pressures in the middle ear can be simulated is quite particularly preferred. This allows pathological conditions of the middle ear to be represented.

The ossicular chain is mobile, and various scenarios can be examined audiologically: implantation of active middle ear hearing aids; tympanoplasty (according to Wullstein type 1-5); stapesplasty; tympanic membrane reconstructions; insertion of tympanostomy tubes.

The simulation models for auditory ossicles can, for example, be printed 20% smaller and subsequently covered with a silicone layer and connected to one another.

Developments of this class of embodiments of the invention in which the components of the first functional portion that simulate the mechanical properties of functional structures of the human middle ear are modeled or simulated in their geometry, relative position and angular orientation to one another, and in their soft tissue properties on the corresponding anatomical components of the human middle ear, are of particular practical advantage.

Embodiments of the simulator system according to the invention that are characterized in that the closed cavity of the second functional portion has a pressure equalization window which is modeled on the human cochlea (round window), are also particularly preferred.

With regard to the required realistic representation, a design of embodiments of the invention is particularly favorable in which the functional portions of the physical ear model are produced on the basis of the anatomical structure and the static and dynamic properties of parts of the human ear, in particular on the basis of laboratory tests and by means of CT images.

A class of embodiments of the simulator system according to the invention that are characterized in that an expert system and/or artificial intelligence with which information based on the measured and/or simulated parameter data can be compared to specified standard values is implemented in the evaluation module is also quite particularly preferred.

Specific developments of this class of embodiments are characterized in that the evaluation module is designed such that it optically simulates the normal transmission behavior of an implant inserted into the simulator system, in the frequency range of human speech, in particular, between 125 Hz and 16 KHz, and compares it in real time during validation to an acoustic signal transmission of healthy human hearing.

The scope of the present invention also includes a method for producing a simulator system of the above-described type according to the invention, which is characterized in that the cavity is initially produced with at least two openings for later filling by the liquid, and that, after filling the cavity with the liquid, all openings are subsequently sealed in a fluid-tight, in particular liquid-tight, manner, preferably by means of the action of UV radiation.

At least one of the openings serves to fill the corresponding cavity with liquid, and at least one other serves to allow air to escape from the cavity.

In a particularly preferred variant of the production method according to the invention, the cavity is produced by means of a 3D printing process and preferably from CT-compatible materials to be hollow and tubular, preferably on the basis of high-resolution CT data sets of originals of the areas of the human body to be simulated.

The simulators according to the invention should be able to provide CT-compatible images (even after manipulation) in order to ensure objective control of the results. Different materials with the same reference (e.g., an implant or another object that is visible in the CT image) are examined in the CT for this purpose.

Further features and advantages of the invention are apparent from the following detailed description of embodiments of the invention, with reference to the figures of the drawing, which show details essential to the invention, and from the claims.

The individual features can each be implemented individually or together in any combination in variants of the invention. The embodiments shown and described are not to be understood as an exhaustive list, but, rather, have an exemplary character for the description of the invention.

### DETAILED DESCRIPTION OF THE DRAWINGS

The schematic drawing shows embodiments of the invention which are explained in greater detail in the following description. In detail:

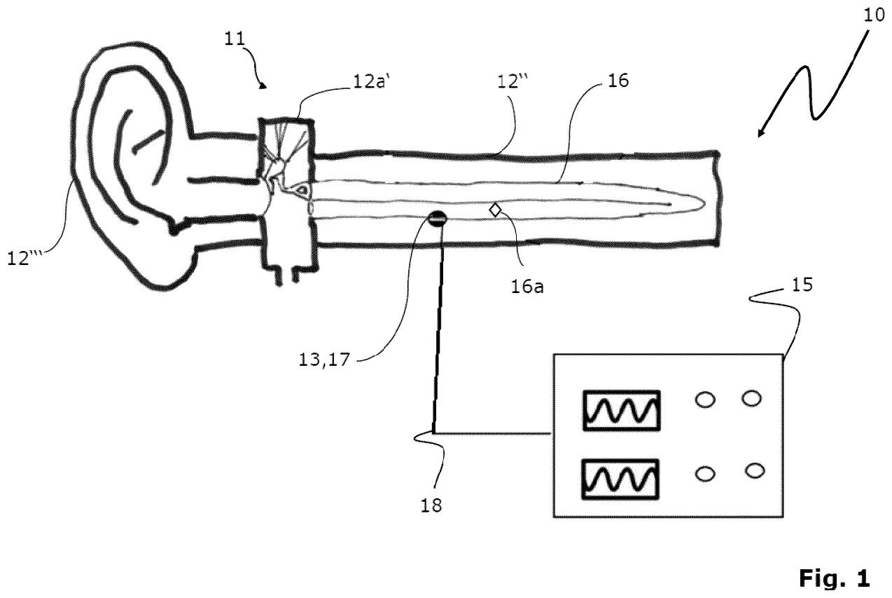

FIG. 1 is a schematic representation of an embodiment of the simulator system according to the invention with a physical ear model in a spatial sectional view, and with an evaluation module (represented symbolically) and the electrical signal line leading thereto from a detection device in the ear model;

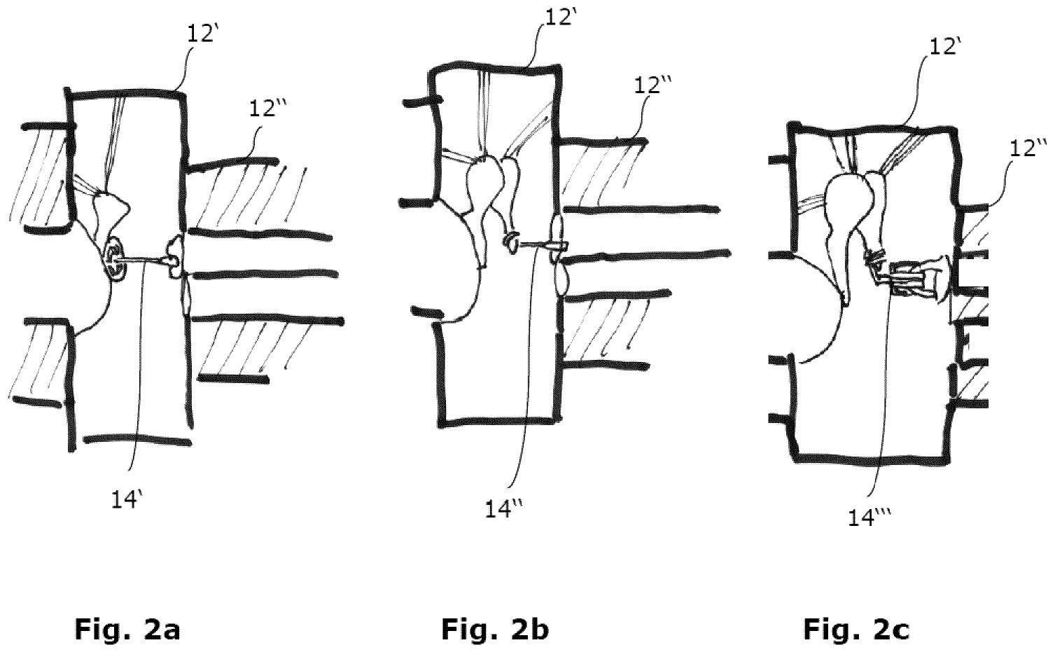

FIG. 2a is a schematic detailed representation of an embodiment of the simulator system according to the invention in a vertical section and of a total prosthesis (tympanoplasty) for later bridging the human ossicular chain with a tympanic membrane head plate at one end and a bell-shaped connection piece to the inner ear at the other end as a passive middle ear implant inserted for testing into the first functional portion;

FIG. 2b is like FIG. 2a, but with a partial prosthesis (stapesplasty) inserted for testing into the first functional portion, with a hook-shaped fastening device for an auditory ossicle at one end and a piston as a connection to the inner ear at the other end as a passive middle ear implant;

FIG. 2c is like FIG. 2b, but with a partial prosthesis inserted for testing into the first functional portion, with a clip-shaped fastening device for an auditory ossicle at one end and another clip as a connection to the stirrup at the other end as a passive middle ear implant;

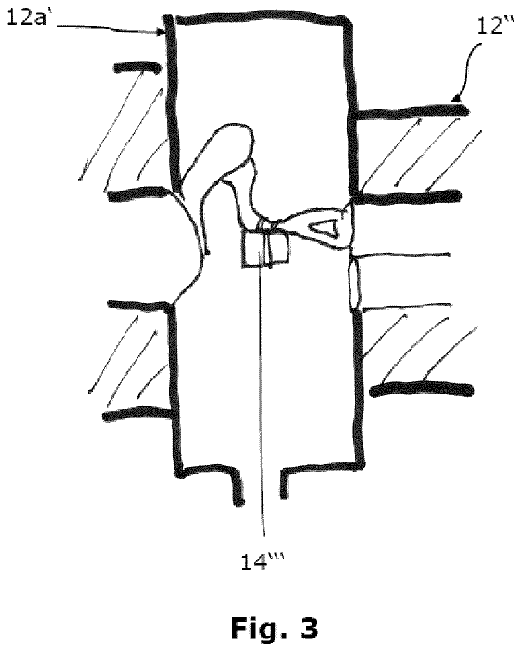

FIG. 3 is a schematic detailed representation of an embodiment of the simulator system according to the invention in a vertical section and of an active middle ear implant inserted for testing into the, here pumpable, first functional portion of the middle ear model;

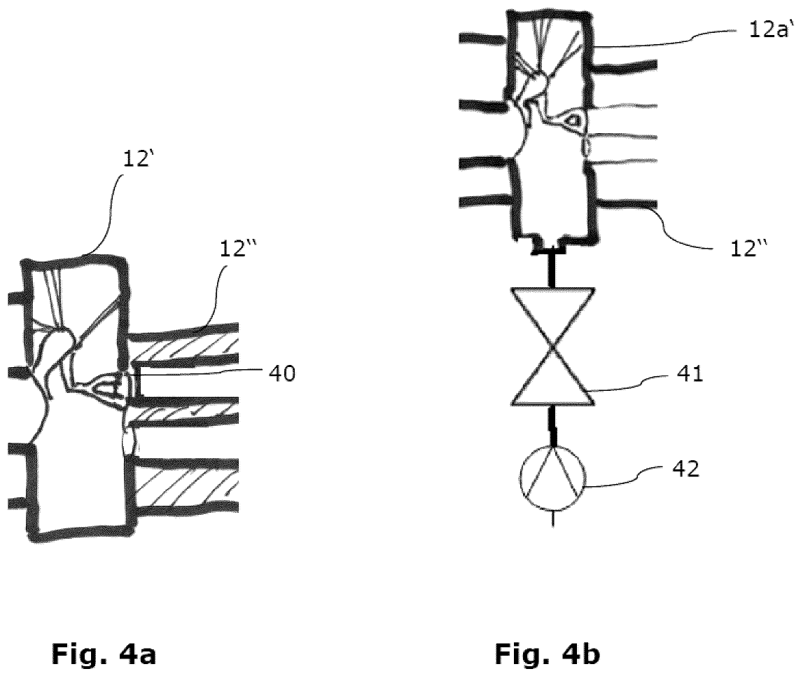

FIG. 4a is a schematic detailed representation of an embodiment of the simulator system according to the invention in a vertical section with a pressure equalization window between the first and the second functional portion;

FIG. 4b is a schematic detailed representation of an embodiment of the simulator system according to the invention in a vertical section with a pumpable first functional portion as well as a valve and a pump connected thereto, both represented symbolically;

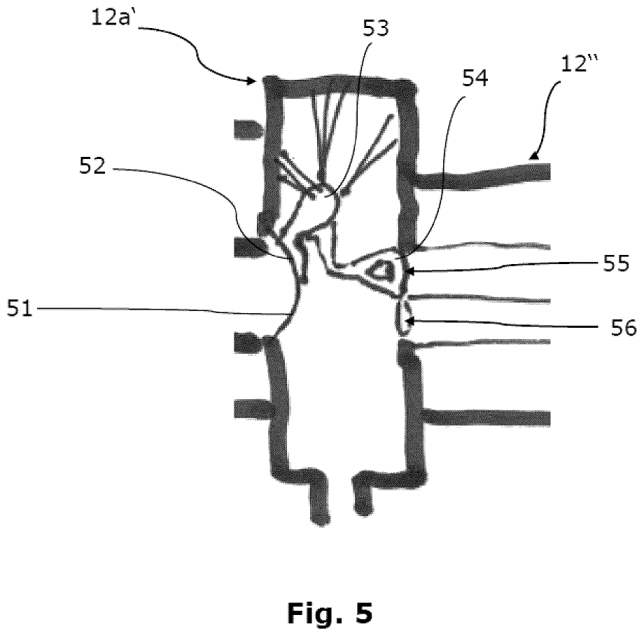

FIG. 5 is a schematic detailed representation of an embodiment of the simulator system according to the invention in a vertical section with a first functional portion of the middle ear model with functional components installed therein, which simulate the mechanical properties of the tympanic membrane, the ligaments and tendons of the middle ear, and the middle ear ossicles including their joint portions;

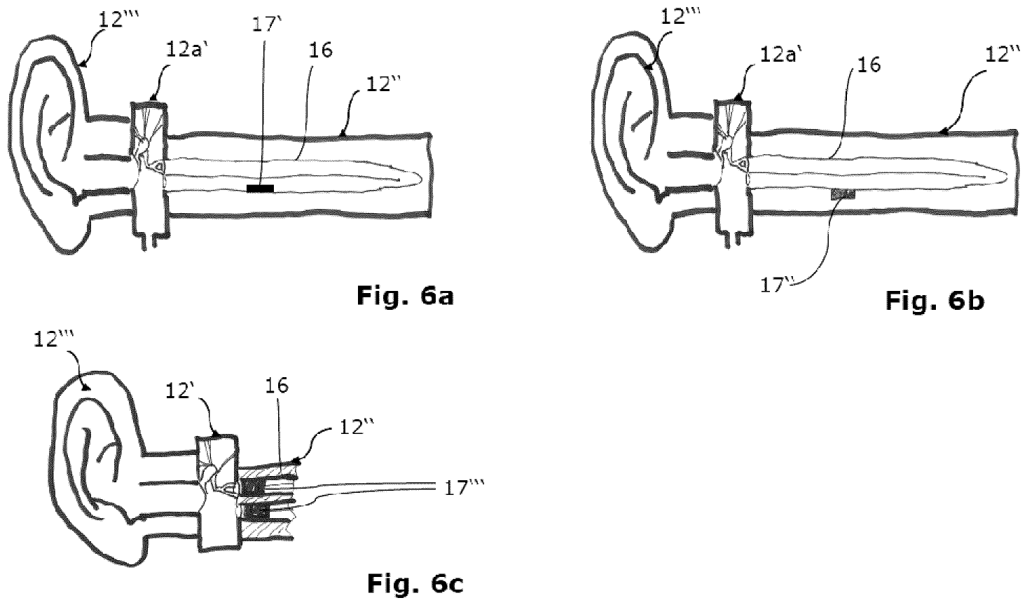

FIG. 6a is a schematic representation of an embodiment of the physical ear model of a simulator system according to the invention in a vertical section with a pressure probe arranged on an inner surface of the closed cavity of the second functional portion, designed as a hydrophone and at least partially surrounded by liquid;

FIG. 6b is like FIG. 6a, but with a pressure probe designed as a pressure sensor arranged on an outer surface of the closed cavity of the second functional portion;

FIG. 6c is a schematic partial representation of an embodiment of the physical ear model of a simulator system according to the invention in a vertical section with a pressure probe arranged in the second functional portion at the transition to the first functional portion, which pressure probe here comprises two air microphones; and

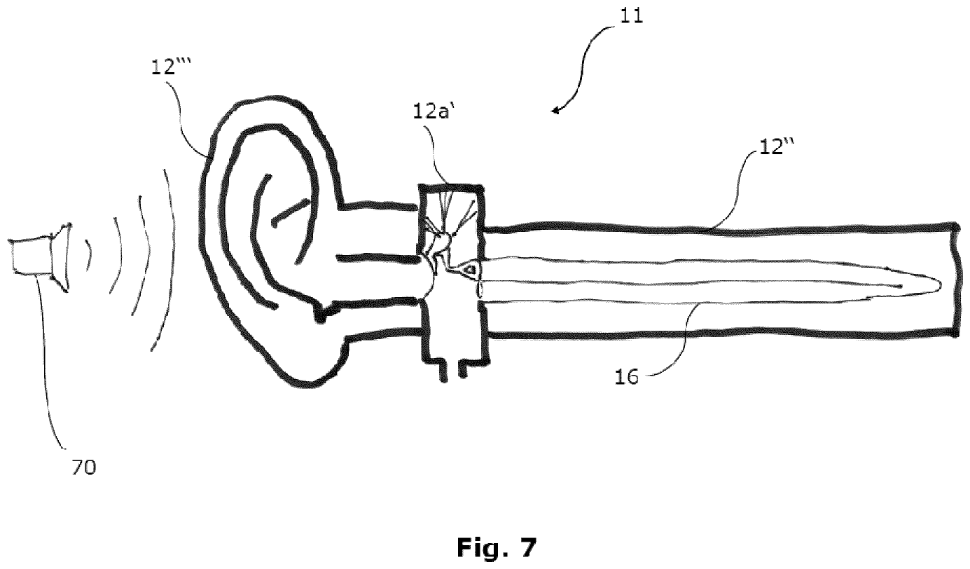

FIG. 7 is a schematic representation of an embodiment of the physical ear model of a simulator system according to the invention like in FIG. 1 in a vertical section with a loudspeaker (represented symbolically) providing sound to the ear model from the third functional portion thereof.

### DETAILED DESCRIPTION OF EMBODIMENTS OF THE INVENTION

The embodiments of the simulator system 10 according to the invention shown schematically, partly only in detail, in the figures of the drawing are used to carry out measurements of acoustic properties of passive and/or active middle ear implants. The system contains a physical ear model 11 for simulating parts of the human ear, comprising a first functional portion 12′; 12a′, which models the human middle ear, a detection device 13 for measuring selected, time-varying acoustic parameters of a middle ear implant inserted into the first functional portion 12′, and an evaluation module 15, which stores and evaluates parameter data measured with the detection device 13.

The simulator system 10 according to the invention is characterized in that the physical ear model 11 contains exclusively artificial materials, including plastics and/or metal parts, and under no circumstances preparations of cadaver parts.

As shown schematically in FIG. 1, the physical ear model 11 comprises a second functional portion 12″, which models the human inner ear and has a closed cavity 16, which is filled with a liquid 16a, which is indicated here only symbolically as a diamond within the cavity 16 and which is to simulate the inner ear fluid.

When producing a simulator system 10 according to the invention, the cavity 16 is generally initially produced with at least two openings for later filling by the liquid 16a. After filling the cavity 16 with the liquid 16a, all openings are subsequently sealed in a liquid-tight manner, most simply by the action of UV radiation.

Preferably, the cavity 16 is produced by means of a 3D printing process to be hollow and tubular, in particular on the basis of high-resolution CT data sets of originals of the areas of the human body to be simulated, as explained in detail below.

The liquid 16a in the cavity 16 is to simulate the inner ear fluid and contain exclusively physiologically harmless, in particular non-toxic substances.

Furthermore, the detection device 13 comprises at least one pressure probe 17, which is arranged on an outer wall or within the closed cavity 16 of the second functional portion 12″.

At least one electrical signal line 18 leads from the detection device 13 to the evaluation module 15, via which signal line the parameter data measured with the detection device 13 can be transmitted directly to the evaluation module 15.

The physical ear model 11 for simulating parts of the human ear preferably also has a third functional portion 12′″, which is modeled on the human outer ear and in particular simulates the sound conduction properties thereof.

The functional portions 12′; 12″; 12′″ can be connected to one another via a flange system (not shown separately in the drawing).

The physical ear model 11 thus generally comprises a model for the outer ear (third functional portion 12′″), for the middle ear (first functional portion 12′), and for the cochlea (second functional portion 12″). The physical ear model was produced on the basis of the anatomical structures and of the static and dynamic properties of corresponding parts of the human ear, in particular, on the basis of laboratory tests and by means of CT images, and implemented in the simulator system 10 according to the invention.

With this simulator system 10 according to the invention, standard measurements using established methods, e.g., ASTM F2504.24930-1 or tympanometry, should be possible in the future. Furthermore, validations for surgical robots, for example, or various other standard measurements as well as calibration tasks are to be performed.

According to the invention, an expert system and/or artificial intelligence with which information based on the measured and/or simulated parameter data can be compared to specified standard values for middle ear implants is implemented in the evaluation module 15.

Preferably, the evaluation module 15 can be designed such that it simulates the normal transmission behavior of an inserted implant in the frequency range of human speech, in particular, between 125 Hz and 16 kHz, and compares it in real time during validation to an acoustic signal transmission of healthy human hearing.

FIG. 2a shows part of the physical ear model 11 of an embodiment of the simulator system 10 according to the invention, the first functional portion 12′ of which is equipped with a passive middle ear implant 14′ in the form of a total prosthesis (tympanoplasty) for later bridging the human ossicular chain. This total prosthesis comprises at one end a tympanic membrane head plate, which, after implantation, then rests against the patient's tympanic membrane from the inside, captures external sound waves arriving from the tympanic membrane, from the tympanic membrane movement evoked as a result and mechanically transmits them to a central part of the implant 14′. At the other end of the implant 14′ in this exemplary embodiment, there is a bell-shaped acoustic connection to the patient's inner ear.

The configuration of FIG. 2a is to test the proper functioning of the passive middle ear implant 14′.

FIG. 2b is a detail of the physical ear model 11 of a similar embodiment of the simulator system 10 according to the invention as shown in FIG. 2a. Here, too, a passive middle ear implant 14″ is inserted for testing into the first functional portion 12′, which implant is however here designed as a partial prosthesis (stapesplasty). The partial prosthesis has a substantially hook-shaped fastening device for an auditory ossicle at one end and a piston at the other end as a direct acoustic connection to the patient's inner ear after implantation.

FIG. 2c also indicates a passive middle ear implant 14′″ inserted into the first functional portion 12′ of the physical ear model 11 for a testing process in the simulator system 10 according to the invention. This implant is also designed as a partial prosthesis for later bridging only part of the human ossicular chain. However, instead of a hook, it contains a clip-shaped fastening device at one end for holding it on an auditory ossicle and another clip at its other end for connecting it to the patient's stirrup foot bone after implantation of the middle ear prosthesis.

In contrast to the embodiments of FIGS. 2a to 2c, FIG. 3 shows outlines of an active middle ear implant 14′″ inserted into the first functional portion 12a′ of the middle ear model 11 for a testing process in the simulator system 10 according to the invention. In this embodiment, the cavity of the first functional portion 12a′ is designed to be pumpable, as is also the case in FIG. 1.

FIG. 4a is a schematic partial representation of an embodiment of the middle ear model 11, in which a pressure equalization window 40 is provided between the (here not pumpable) first functional portion 12′ and the second functional portion 12″. The pressure equalization window 40 is modeled on the human cochlea (in particular the round window).

FIG. 4b in contrast shows an embodiment of the invention with a pumpable first functional portion 12a′. Connected thereto is a valve 41 and subsequently a pump 42, each represented symbolically.

The schematic detailed representation of FIG. 5 shows a (here again pumpable) first functional portion 12a′ of the middle ear model 11 according to the invention, which models the human middle ear. Installed therein are anatomical functional components that are to simulate the mechanical properties of functional structures of the human middle ear, in particular, the tympanic membrane, the ligaments and tendons of the middle ear, the middle ear ossicles and the middle ear joints, such as the incudomalleolar joint and the incudostapedial joint.

The anatomical functional components are modeled on or simulate in their geometry, their relative position and angular orientation to one another within the first functional portion 12a′ representing the human middle ear, as well as in their soft tissue properties, the corresponding natural anatomical components of the human middle ear.

In detail, the following anatomical functional components are provided in the embodiment of FIG. 5:

A model of the tympanic membrane 51, a model of the hammer bone 52, a model of the anvil bone 53, a model of the stirrup bone 54, a model of the oval window 55, and a model of the round window 56.

FIG. 6a is a schematic representation of an embodiment of the physical ear model 11 of a simulator system 10 according to the invention similar to that in FIG. 1. In the second functional portion 12″, a pressure probe designed as a hydrophone 17′ and at least partially surrounded by liquid 16a (not shown separately here) is arranged on an inner surface of the closed cavity 16. Part of the electrical signal line 18 (also not shown separately here) from the hydrophone 17′ passes in a sealed manner through a wall of the closed cavity 16 and through the wall of the second functional portion 12″ and then leads into the evaluation module 15.

An alternative to the embodiment of FIG. 6a is shown in FIG. 6b: Here, the pressure probe 17 comprises a pressure sensor 17″, which is arranged on an outer wall of the closed cavity 16 and therefore does not require sealing. In addition, such a pressure sensor 17″ is significantly more cost-effective than a hydrophone 17′. The hydrophone, however, probably represents the sound conduction to the human inner ear somewhat more accurately.

The schematic partial representation of FIG. 6c represents an embodiment of the physical ear model 11 of a simulator system 10 according to the invention, in which a pressure probe 17 is arranged in the second functional portion 12″ at the transition to the first functional portion 12′, which pressure probe here comprises two air microphones 17′″.

The hydrophone 17′ and/or the pressure sensor 17″ and/or the air microphones 17′″ of the pressure probe 17 each generally have a diameter between 0.5 mm and 5 mm, in particular between 1 mm and 2 mm.

FIG. 7 finally is a schematic representation, similar to FIG. 1, of an embodiment of the physical ear model 11 of a simulator system 10 according to the invention with a loudspeaker 70 (represented symbolically with emitted sound waves) providing sound to the ear model 11 from the third functional portion 12′″ thereof (which simulates the human outer ear).

### LIST OF REFERENCE SIGNS

10 simulator system
11 physical ear model
12′ first functional portion (middle ear model)
12a′ pumpable first functional portion
12″ second functional portion (inner ear model)
12′″ third functional portion (outer ear model)
13 detection device
14′;14″;14″′ passive middle ear implants
14″″ active middle ear implant
15 evaluation module
16 closed cavity
16a liquid in the cavity
17 pressure probe
17′ hydrophone
17″ pressure sensor
17′″ air microphone
18 electrical signal line
40 pressure equalization window
41 valve
42 pump
51 tympanic membrane model
52 hammer model
53 anvil model
54 stirrup model
55 model of oval window
56 model of round window
70 loudspeaker

### LIST OF REFERENCES

### Publications Considered for the Assessment of Patentability

[1] International ASTM F2504-05 standard “Standard Practice for Describing System Output of Implantable Middle Ear Hearing Devices” under the jurisdiction of ASTM Committee F04 on Medical and Surgical Materials and Devices, Subcommittee F04.37 on Implantable Hearing Devices, approved March 1, 2014 and published April 2014, DOI: a0.1520/F2504-05R14, available from http://www.ansi.org
[2] Kuru I, Maier H, Muller M, Lenarz T, Lueth TC. “A 3D-printed functioning anatomical human middle ear model,” Hear Res. 2016 Oct; 340:204-213, doi: 10.1016/j.heares.2015.12.025, Epub 2016 Jan 7, PMID: 26772730
[3] DE 10 2018 118 918 B3
[4] DE 10 2005 041 942 A1
[5] G. Strauss et al., “Evaluation eines Trainingssystems für die Felsenbeinchirurgie mit opto-elektronischer Detektion” [Evaluation of a training system for petrosal bone surgery with opto-electronic detection], HNO 2009·57:999-1009, Springer Medizin Verlag, August 20, 2009
[6] Shawn B. Mathews et al., “Incus and Stapes Footplate Simulator,” Laryngoscope 107: December 1997, 1614-1616
[7] A. O. Owa et al., “A middle-ear simulator for practicing prostheses placement for otosclerosis surgery using ward-based materials,” The Journal of Laryngology & Otology, June 2003, vol. 117, pp. 490-492
[8] Robert Mills et al., “Surgical skills training in middle-ear surgery,” The Journal of Laryngology & Otology, March 2003, vol. 117, pp. 159-163
[9] Evan A. Longfield et al., “3D Printed Pediatric Temporal Bone: A Novel Training Model,” Otology & Neurotology, 2015, 36:793-795
[10] Konrad Entsfellner et al., “A new physical temporal bone and middle ear model with complete ossicular chain for simulating surgical procedures,” Proceedings of the 2015 IEEE Conference of Robotics and Biomimetics, Zhuhai, China, pp. 1654-1659
[11] Matthew M. Dedmon et al., “Development and Validation of a Modular Endoscopic Ear Surgery Skills Trainer,” Otology & Neurotology, 2017, 38:1193-1197
[12] Yann Nguyen et al., “Modifications to a 3D-printed temporal bone model for augmented stapes fixation surgery teaching,” Eur Arch Otorhinolaryngol, 2017, 274:2733-2739
[13] T. Beleites et al., “From reconstruction to function. Hands-on training in tympanoplasty using real-time feedback,” HNO 7, 2021, 69:556-561
[14] Jan Christoffer Luers et al., “Surgical anatomy and pathology of the middle ear,” J. Anat. (2016) 228, pp. 338-353
[15] Dominik Péus et al., “Sheep as large animal ear model: Middle-ear ossicular velocities and intracochlear sound pressure” in Hearing Research (2017), vol. 351, pp. 88-97
[16] Martin Grossohmichen et al., “Validation of methods for prediction of clinical output levels from measurements in human cadaveric ears” in Scientific Reports (2017), vol. 7, no. 1, pp. 1-10
[17] CN 110246404 B

What is claimed is:

1. A simulator system for carrying out measurements of acoustic properties of passive middle ear implants, comprising:
a physical ear model for simulating parts of the human ear, comprising a first functional portion, which models the human middle ear, with a detection device for measuring selected, time-varying acoustic parameters of a middle ear implant inserted into the first functional portion, and with an evaluation module, which stores and evaluates parameter data measured with the detection device;
wherein the physical ear model contains exclusively artificial materials including plastics and/or metal parts;
wherein the physical ear model comprises a second functional portion, which models the human inner ear and has a closed cavity filled with liquid;
wherein the detection device comprises at least one pressure probe, which is arranged on an outer wall or within the closed cavity of the second functional portion;
wherein the pressure probe comprises a hydrophone, which is arranged, at least partially surrounded by the liquid, within the closed cavity;
wherein the hydrophone is arranged on an inner surface of the closed cavity of the second functional portion;
wherein at least one electrical signal line leads from the detection device to the evaluation module, via which signal line the parameter data measured with the detection device can be transmitted directly to the evaluation module;
and wherein part of the electrical signal line passes in a sealed manner through a wall of the closed cavity and leads into the hydrophone.

2. The simulator system according to claim 1, wherein the pressure probe comprises a pressure sensor, which is arranged on an outer wall of the closed cavity and into which part of the electrical signal line leads.

3. The simulator system according to claim 1, wherein the hydrophone and/or the pressure sensor of the pressure probe each have a diameter between 0.5 mm and 5 mm.

4. The simulator system according to claim 1, wherein the hydrophone and/or the pressure sensor of the pressure probe each have a diameter between 1 mm and 2 mm.

5. The simulator system according to claim 1, wherein the physical ear model for simulating parts of the human ear comprises a third functional portion, which models the human outer ear and simulates the sound conduction properties thereof.

6. The simulator system according to claim 1, wherein the functional portions are connected to one another via a flange system.

7. The simulator system according to claim 1, wherein the first functional portion, which models the human middle ear, has components which simulate the mechanical properties of the tympanic membrane, the ligaments and tendons of the middle ear, the middle ear ossicles and the middle ear joints being the incudomalleolar joint and the incudostapedial joint.

8. The simulator system according to claim 6, wherein the components of the first functional portion that simulate the mechanical properties of functional structures of the human middle ear are modeled on or simulate in their geometry, relative position and angular orientation to one another, as well as their soft tissue properties, the corresponding anatomical components of the human middle ear.

9. The simulator system according to claim 1, wherein the closed cavity of the second functional portion has a pressure equalization window, which is modeled on the human cochlea (round window).

10. The simulator system according to claim 1, wherein the functional portions of the physical ear model are produced on the basis of the anatomical structure and the static and dynamic properties of parts of the human ear, in particular on the basis of laboratory tests and by means of CT images.

11. The simulator system according to claim 1, wherein an expert system and/or artificial intelligence with which information based on the measured and/or simulated parameter data can be compared to specified standard values is implemented in the evaluation module.

12. The simulator system according to claim 10, wherein the evaluation module is designed wherein it optically simulates the normal transmission behavior of an inserted implant in the frequency range of human speech, between 125 Hz and 16 kHz, and compares it in real time during validation to an acoustic signal transmission of healthy human hearing.

13. A method for producing the simulator system according to claim 1, wherein the cavity is initially produced with at least two openings for later filling by the liquid, and in that, after filling the cavity with the liquid, all openings are subsequently sealed in a liquid-tight manner, by means of the action of UV radiation.

14. The method according to claim 12, wherein the cavity is produced by means of a 3D printing process to be hollow and tubular, on the basis of high-resolution CT data sets of originals of the areas of the human body to be simulated.
